(19) United States
(12) Patent Application Publication
(10) Pub. No.: US 2017/0223961 A1
(43) Pub. Date: Aug. 10, 2017

(54) HERBICIDAL FORMULATION WITH DOUBLE ACTION MECHANISM FOR CONTROLLING WEEDS, METHOD FOR CONTROLLING UNDESIRABLE WEEDS AND METHOD FOR INCREASING HARVEST YIELD

(71) Applicant: FMC QUÍMICA DO BRASIL LTDA, Sao Paulo (BR)

(72) Inventors: Alessandro Leal NOGUEIRA, Sao Paulo (BR); Rodrigo Tavares MARQUES, Sao Paulo (BR); Yemel ORTEGA, Marlton, NJ (US); Danilo TUBALDINI, Sao Paulo (BR); Ricardo WELANG, Sao Paulo (BR)

(73) Assignee: FMC QUÍMICA DO BRASIL LTDA, Sao Paulo (BR)

(21) Appl. No.: 15/500,496

(22) PCT Filed: Jul. 28, 2015
(86) PCT No.: PCT/BR2015/000113

§ 371 Date: Jan. 30, 2017

(30) Foreign Application Priority Data
Jul. 30, 2014 (BR) BR102014018735-9

(51) Int. Cl. A01N 43/653; A01N 35/02; A01N 43/82

(52) U.S. Cl. CPC A01N 43/653; A01N 43/82; A01N 35/02; A01N 2300/00

(57) ABSTRACT

The present invention refers to a dual mode of action herbicidal formulation for controlling weeds in sugarcane culture during the humid season comprising at least one herbicide pesticide selected from the group of triazolinones and at least one herbicide pesticide selected from the group of urea. The present invention further refers to methods for controlling undesirable weeds, comprising applying the formulation of the present invention to plants, thereby providing a faster initial development of the crop, providing higher production levels and increasing crop yield, in addition to the longevity of the sugarcane plantation.

### FIELD OF THE INVENTION

The present invention refers to the control of weeds that affect sugarcane during the wet season, soybean, coffee and citrus. The present invention also refers to a dual mode of action herbicidal formulations comprising triazolinones in synergic combination with substituted urea pesticides. The invention also refers to a method for controlling weeds and to a method for increasing crop yield.

### BACKGROUND OF THE INVENTION

The control of grasses such as Panicum maximum, Brachiaria decumbens, Brachiaria plantaginea, Digitaria horizontalis, Digitaria nuda and Digitaria sp and of broad-leaved weeds, such as Amaranthus SP, Euphorbia heterophylla, Mucuna pruriens, Riccinus comunis and of different species if morning glories (Ipomoea grandifolia, Ipomoea quamoclit, Ipomoea nil, Ipomoea hederfolia, Ipomoea purpúrea, Merremia cissoides e Merremia aegypta) in cultures of sugarcane, coffee, citrus and soybean has been an ongoing problem. Brazil is the largest producer of sugarcane in the world, grinding approximately 640 million tons per year and with a cultivated area of 9 million hectares. The Southeast region with 60% (the state of Sao Paulo alone represents 52% of the cultivated area) and the Northeast region with 21% of the total cultivated area, are the major producing regions of the country. The average productivity in these two regions is 78 and 55 ton/ha, respectively With regard to soybean culture, Brazil has a planted area of approximately 31.6 million hectares, while coffee cultures cover an area of 2.23 million and citrus 643,000 hectares.

The area for sugarcane cultures in Brazil is currently 9 million hectares, with an estimated growth to 13 million hectares in the next three years, while the area for soybean crops is 31.6 million hectares, with a strong growth trend when compared to other cultures. The area cultivated with coffee covers 2.23 million ha and tends to be stable, however due to the biennial characteristic of the production, the pressure for higher productivity and cost optimization is growing. For citrus crops, the planted area is also stable, i.e., 643,000 ha, however the citrus sector must be prepared to face the evolution and the increased complexity of the market, considering the fluctuations in the fruit supply in the main producer regions in the world, which highlight the need for greater control over production costs and higher productivity levels. One of the most critical points in the production process of sugarcane, soybean, coffee and citrus crops is the negative interference imposed by weeds that infest cultivated areas. These weeds compete for limiting environmental resources such as water, light and nutrients, release allelopathic substances and can also host pests and pathogens of diseases common to the above mentioned crops, in addition to interfering in the productivity levels of sugarcane, soybean, coffee and citrus, in the crop yield and in the longevity of the sugarcane plantations, coffee plantations and orchards. For sugarcane plantations, in the Mid-South and Northeast regions, some grasses are of particular importance in traditional areas of sugarcane cultures such as Surinam grass (Brachiaria decumbens), Alexandergrass (Brachiaria plantaginea), Guinea grass (Panicum maximum) and crabgrass species complex (Digitaria horizontalis, Digitaria nuda, Digitaria bicornis, Digitaria ciliares and Digitaria sp), among other grasses present in areas of sugarcane expansion, such as beard grass or palisade (Brachiaria brizantha), crowfoot grass (Eleusine indica) and southern sandbur or burr grass (Cenchrus echinatus). For the soybean culture, the most harmful weeds besides grasses such as Alexandergrass (Brachiaria plantaginea), Surinam grass (Brachiaria decumbens), Guinea grass (Panicum maximum), hairy crabgrass or wild crabgrass (Digitaria ciliaris), Southern sandbur or burr grass (Cenchrus echinatus), are different species of weeds tolerant to the glyphosate post-emergence herbicide, wild poinsettia or milkweed (Euphorbia heterophylla), beggar-ticks (Bidens pilosa), Benghal dayflower (Commelina bengalensis) and others, and weeds resistant to glyphosate such as horseweed (Conyza sp), sourgrass (Digitaria insularis) and annual ryegrass (Lolium multiflorum).

For the sugarcane culture, with the introduction of mechanized harvesting without the burning of the sugarcane straw, there were significant changes in the sugarcane production environments, with significant impact on the selection of the weed species that make up the infesting communities. Several researchers have evaluated the differential behavior between the species with regard to germination and emergence, in relation to the maintenance of the straw layer and to the resultant microclimatic changes. It appears that some species of weeds are characterized by having broad leaves, such as the different species of spiny amaranth (Amaranthus spp) and purslane or pigweed (Portulaca oleracea), velvet bean or mucuna (Mucuna pruriens), castor oil plant (Riccinus comunis) among others, which are often found in areas of sugarcane plantations in soils with good fertility and high organic matter content, or in soils wherein filter-cake is used as part of the fertilization, and plants that were selected by some commonly used herbicides such as mussabe or spiderwisp (Cleomis affinis) and wild poinsettia or milkweed (Euphorbia heterophylla) and/or in raw cane environments such as horseweed (Conyza sp), ragweed parthenium (Parthenium hysterophorus), hyssopleaf sandmat (Chamaescyce hyssopifolia) and lobed croton (Croton lobatus) and tooth-leaved croton or vente conmigo (Croton glandulosus). A number of weed species popularly known as morning-glory play a major role among infesting communities of the sugarcane culture, particularly among the areas of raw cane harvest. These species belong to the genera Ipomoea and Merremia, of the Convolvulaceae family. Within the genus Ipomoea, the following stand out: I. hederifolia, I. quamoclit, I. nil, I. grandifolia and I. purpurea, while in genus Merremia, M. cissoides and M. aegyptia stand out. For soybean, coffee and citrus crops, the selection of weeds is due to the intensive use of glyphosate herbicide applications, such as horseweed (Conyza sp), sourgrass (Digitaria insularis), annual ryegrass (Lolium multiflorum) and tolerant plants such as Benghal dayflower (Commelina benghalensis), buttonweed or broad-leaved buttonweed (Spermacoce latifola) and other weeds.

The breakdown of the sugarcane, soybean, coffee and citrus production cost, the expenses for weed control are of great importance. According to Kuva et al. (2003) and other authors, the interference caused by weeds in sugarcane significantly reduces crop yield (reductions of up to 20% to 80% in production), in addition to other negative aspects, such as decrease in the longevity of the sugarcane plantation (decrease in 2 to 3 crop cycles) and of the coffee plantation and orchard, decrease in the quality of the raw material (sucrose content, quality of the coffee, brix content of orange and soybeans), as well as difficulty in harvesting and transport operations of these crops. Thus, there is a clear need for effective strategies for managing/controlling the weeds that infest such cultures, thus being essential the recommendation and use of broad-spectrum control herbicides and with different mechanisms of action, as an example of this technological innovation.

In Brazil alone, an annual market of US$12 million for sugarcane is estimated, the significant markets for soybean, coffee and citrus not being included in these numbers. To allow an integrated handling and control of weeds, assertively and effectively, thereby reducing the damage to productivity, crop yield and longevity of the culture, it should be noted the importance of novel broad spectrum control herbicides and the high selectivity of such herbicides to the cultures. The present invention provides a new pesticide combination that has a broad spectrum control for sugarcane, soybean, coffee and citrus.

The product of the present invention is the first broad-spectrum herbicide for controlling weeds that are difficult to control in major agricultural crops such as sugarcane, soybean, coffee and citrus. In the research and development work carried out by the FMC team and by governmental and private research institutions, the efficient control of these weeds in sugarcane, soybeans, coffee and citrus crops was achieved using the formulation of the present invention, with excellent results when compared to a tank mixture of Dinamic (amicarbazone 700 kg/kg—Arysta LifeScience) and Combine (tebuthiuron 500 g/L—DowAgroSciences) in sugarcane, Boral (sulfentrazone 500 g/L—FMC Agricultural Products) and Classic (chlorimuron ethyl 240 g/kg—Dupont do Brasil) in soybean, Flumyzin 500 PM (flumioxazin 500 g/kg—Iharabras) in coffee and citrus.

The formulation of the present invention works by means of two herbicide molecules that act by means of two different mechanisms of action: Protox or Protoporphyrinogen Oxidase (PPO) inhibitors and photosystem II (PS II) photosynthesis inhibitors. The inhibition of protoporphyrinogen oxidase in the presence of light will cause the rupture of the cell membrane and irreversible cell damage while the inhibition of photosynthesis will cause leaf necrosis.

Herbicide sulfentrazone (2′,4′-dichloro-5′-(4-difluoromethyl-4,5-dihydro-3-methyl-5-oxo-1H-1,2,4-triazol-1-yl) methanesulfonanilide) is a selective pre-emergence herbicide with systemic action, from the chemical group of triazolinone—group E (HRAC—Herbicide Resistance Action Committee/WeedScience), its absorption being mainly by the root and the translocation via the xylem, and the movement via limited phloem.

The herbicide sulfentrazone belongs to the group of protoporphyrinogen oxidase IX (PPO) inhibiting herbicides, an enzyme that converts protoporphyrinogen IX to protoporphyrin IX. Then, protoporphyrinogen IX accumulates and diffuses out of the multi-enzymatic complex located in the plastid. Protoporphyrin IX is formed in the cytosol by the oxidation of protoporphyrinogen IX; the protoporphirin IX interacts with oxygen and light to form singlet oxygen. This highly reactive free radical causes peroxidation of the membrane lipids, which causes cell death. As symptoms, susceptible plants emerge from the soil treated with sulfentrazone, becoming necrotic and then dying when exposed to light. Sulfentrazone metabolism involves oxidative hydroxylation of the metal group in the triazole ring.

The sulfentrazone herbicide inhibits the enzyme Protoporphyrinogen IX oxidase (PPO). PPO is present in the synthesis route of chlorophyll and cytochromes, also called synthesis of porphyrin or of tetrapyrroles (Merotto & Vidal, 2001). The mechanism of action of PPO-inhibiting herbicides is based on the inhibition of the transformation reaction of protoporphyrinogen to protoporphyrin. This reaction is catalyzed by PPO. With the inhibition of this enzyme, present in the chloroplast, protoporphyrinogen accumulates and migrates from the chloroplast to the cytoplasm and forms free radicals (oxygen singlet) when in contact with oxygen in the presence of light, causing the peroxidation of the membrane lipids, which damages the plant cell. Until now, one weed biotype resistant to these herbicides in agriculture has been detected, therefore, the probability of selection is restricted (Weed Science, 2003).

In general, the natural tolerance of plant species to Protox (PPO) inhibiting herbicides belonging to Group E (HRAC/WeedScience) is associated with the rapid metabolism of the herbicide in plants, commonly via cytochrome P450 or glutathione conjugation. There may also be lower foliar or root absorption, less translocation, enzyme over production or insensitivity and herbicide scavenging, thus conferring the resistance mechanism to the weeds.

With regard to the behavior of sulfentrazone in the soil, it can be appreciated that this herbicide has moderate absorption and lixiviation due to moderate mobility of the herbicide in the soil, despite the high solubility (Sw 110 mg/L) and low adsorption, the octanol-water partition coefficient being Koc=43 ml/g. The decomposition of sulfentrazone though, is predominantly microbial, photodegradation in the soil being unsusceptible and volatilization negligible. The persistence in the soil is considered high, with a half life (½ life) of 180 days.

Compound 3-(3,4-dichlorophenyl)-1,1-dimetilurea (Diuron) is a nonselective broad spectrum herbicide. Diuron is absorbed by the roots and transported to the leaves, where its mechanism of action (MoA) is to inhibit photosynthesis in photosystem II (PSII). Phytotoxicity symptoms first appear on the leaves that turn to a light green tone, finally becoming necrotic; acute symptoms arise from high concentration of the product and appear in a few days; chronic symptoms arise from low concentrations and take longer to occur, causing chlorosis of the leaves. Crop selectivity may be due to the positioning of diuron in the soil, called toponomics selectivity, and due to the differential metabolism by means of N-demethylation of diuron by some cultures. Diuron has been described in U.S. Pat. No. 2,655,445 and its herbicidal effect is well known for providing good control of various weeds in different cultures, as well as in non-agricultural areas, roads, irrigation and industrial canals.

The weeds that are resistant to herbicides that inhibit photosynthesis in photosystem II (group C—HRAC/WeedScience) are this way because of a mutation process of the plastoquinone (compound Qb), in such a way that the herbicide is not able to couple to the compound, thus not being able to prevent the transport of electrons. Therefore, this plant is able to execute the electron transport in the light phase of photosynthesis even in the presence of the herbicide. An example of weed species with detected resistance to diuron is Amaranthus in Hungary.

As for the behavior of diuron herbicide in the soil, it can be said that diuron is adsorbed by clay and organic matter colloids, which almost prevents it from being lixiviated, except in soils with low organic matter and clay content, with an average octanol-water coefficient of Koc=480 ml/g). The degradation of diuron herbicide in the soil, however is predominantly microbial, being sensitive to photodegradation when exposed on the soil surface for several days or weeks; volatilization losses are negligible, except when exposed on the soil surface for days or weeks under high temperature and low humidity conditions. Another important feature is the persistence of diuron, with an average half life (½ life) of 90 days in field conditions.

The herbicides currently in use that feature a photosynthesis inhibition mechanism belong to three major chemical groups: triazines, substituted urea and uracils. The site of action of these herbicides is in the chloroplast membrane, where the light phase of photosynthesis takes place, specifically in electron transport (Christoffoleti, 1997). A plant is susceptible to photosynthesis inhibiting herbicides if the herbicidal compound couples with the plastoquinone (Qb) compound of the photosynthetic system and thus prevents the electron transport to such system. In this way there is no production of adenosine triphosphate (ATP) as the transport of electrons is disrupted and there is no production of nicotinamide adenine dinucleotide dihydrogen phosphate (NADPH2). However, in a resistant weed there is a mutation process of the Qb compound in such a way that the herbicide cannot be coupled to the compound, thus preventing the transport of electrons. Therefore, there is electron transport in the light phase of photosynthesis in a plant resistant to photosynthesis inhibiting herbicides even in the presence of the herbicide (Christoffoleti, 1997). Worldwide, there have been found 64 resistant biotypes to group C1 (classification based on the mechanism of action according to the criteria established by HRAC—Herbicide Resistance Action Committee), 20 to group C2 and 1 to group C3, according to the information from Weed Science (2003) available at www.weedscience.org.

Herbicide combinations and associations are frequently used to broaden the weed control spectrum of herbicides, thus increasing the control over such pants. In the association of herbicides sulfentrazone and diuron, which have different mechanisms of action, i.e., inhibiting Protox (PPO) and photosystem II (PS II), respectively, a significant synergistic effect of this association was observed when in a single formulation, which is not observed in other cases.

Document PI 0417671-5 refers to a method for controlling conifer plants, particularly conifer plants naturally sown (wild conifers), in which an effective amount of at least one herbicide selected from the group consisting of sulfentrazone, carfentrazone, their agriculturally acceptable salts and their agriculturally acceptable derivatives is applied to conifer plants to be controlled or to their parts, such as roots, leaves, seeds or shoots.

Document PI 9704565-9 refers to selective herbicides comprising a carbamoiltriazolinone compound and one or more herbicidal compounds selected from ametryn, tebuthiuron, hexazinone, isoxaflutole, metribuzin, sulfentrazone and/or diuron.

Document PI 0710376-0 refers to an association of diuron and mesotrione, optionally containing other herbicides such as sulfentrazone and tebuthiuron. An herbicidal composition comprising diuron, mesotrione and optionally other herbicides such as hexazinone and at least one additional component selected from the group consisting of surfactants, solid diluents and liquid diluents is also described. It is further described a method for controlling undesired vegetation comprising applying an herbicidal effective amount of the association to the vegetation site.

Document U.S. 2002004457 refers to a synergic herbicidal composition for controlling broad-leaved weeds and grasses in useful plant crops resistant to protoporphyrinogen oxidase (PPO) inhibitors comprising, besides the customary inert formulation auxiliaries, active compounds such as a) a herbicide which inhibits the PPO action and b) at least one additional pesticide selected from the group consisting of co-herbicides, fungicides and insecticides/acaricides.

Document U.S. Pat. No. 6,444,613 refers to a mixture comprising (A), thidiazuron or thidiazuron and diuron and (B) one or more PPO inhibitors that are suitable for removing the leaves of plants, in particular cotton plants.

### SUMMARY OF THE INVENTION

The present invention refers to a broad spectrum herbicide for controlling weeds for use in sugarcane (cane plant and/or ratoon cane), soybean, coffee and citrus in the wet season. The present invention also refers to herbicidal formulations comprising triazolinones in synergistic association with substituted urea pesticides. The invention also refers to a method for controlling weeds and to a method for increasing crop yield.

Due to the need of a formulation having the aforementioned properties, it is useful to use combinations of pesticides or formulations of one herbicide with another herbicide, insecticide or fungicide, etc., in order to obtain a better control of various weeds and pests with a single application, independently of time and or weather conditions.

Based on this principle, a formulation with an association of herbicides was developed, in particular a formulation comprising the combination of two of the most important active ingredients used in sugarcane, soybean, coffee and citrus crops, i.e., triazolinones, especially the active compound sulfentrazone and urea pesticides, especially the active compound diuron, thus resulting in an herbicide with excellent broad spectrum control of weeds in sugarcane, soybean, coffee and citrus cultures.

The formulation of the present invention provides a better and more efficient control of these weeds when compared to other herbicides registered for sugarcane, soybean, coffee and citrus, especially because of their two distinct mechanisms of action, i.e., inhibiting PPO and the photosystem II (PSII).

### DESCRIPTION OF THE FIGURES

FIG. 1 refers to the performance of the herbicidal formulation of the present invention in the control of scarlet morning glory (Ipomoea hederifolia) at 171 DAA (DAA=days after application) in sugarcane when compared to other herbicides in tank mix.

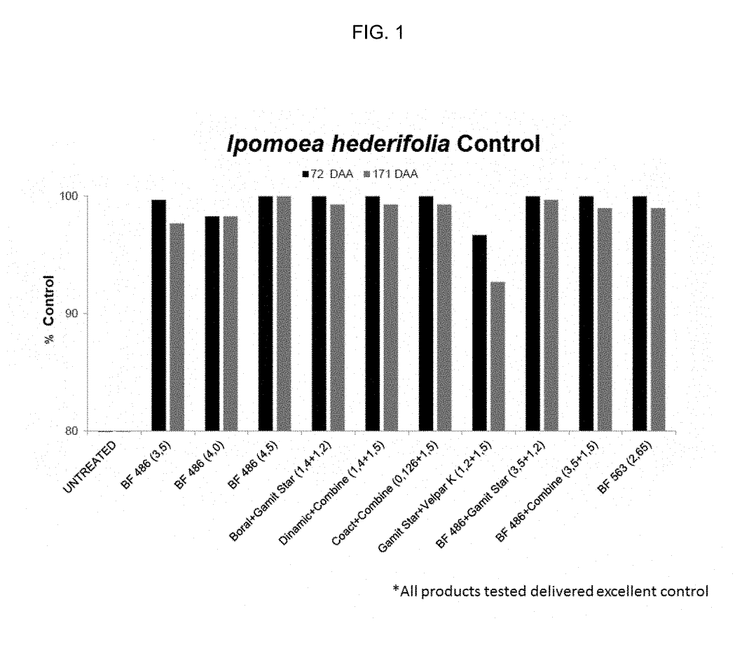

FIG. 2 refers to the performance of the herbicidal formulation of the present invention (Boral DuO—sulfentrazone and diuron association) in the control of Jamaican crabgrass (Digitaria horizontalis) at 150 DAA in sugarcane when compared to other herbicides in tank mix.

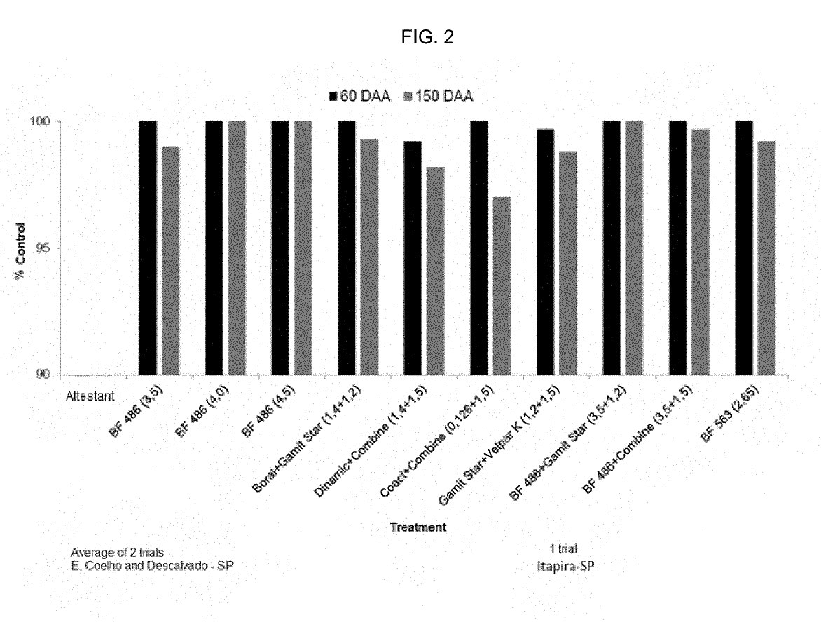

FIG. 3 refers to the performance of the herbicidal formulation of the present invention (Boral DuO—sulfentrazone and diuron association) in the control of scarlet morning glory (Ipomoea hederifolia) at 150 DAA in sugarcane.

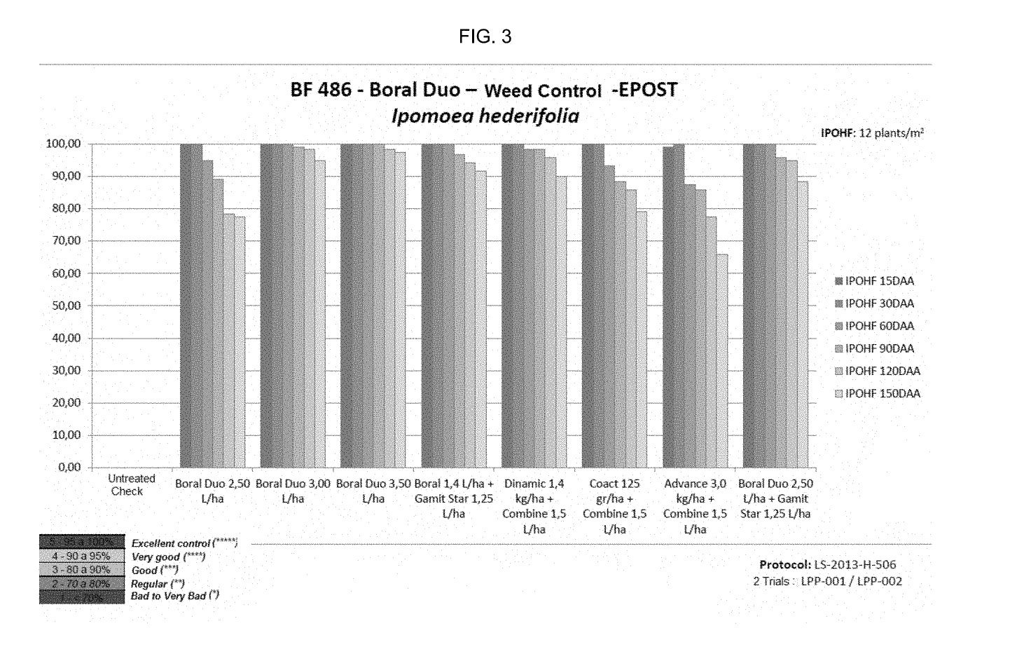

FIG. 4 refers to the chart that shows the results obtained in the control of purple nut sedge (Cyperus rotundus) by the herbicidal formulation of the present invention (Boral DuO—sulfentrazone and diuron association) at 60 DAA in sugarcane.

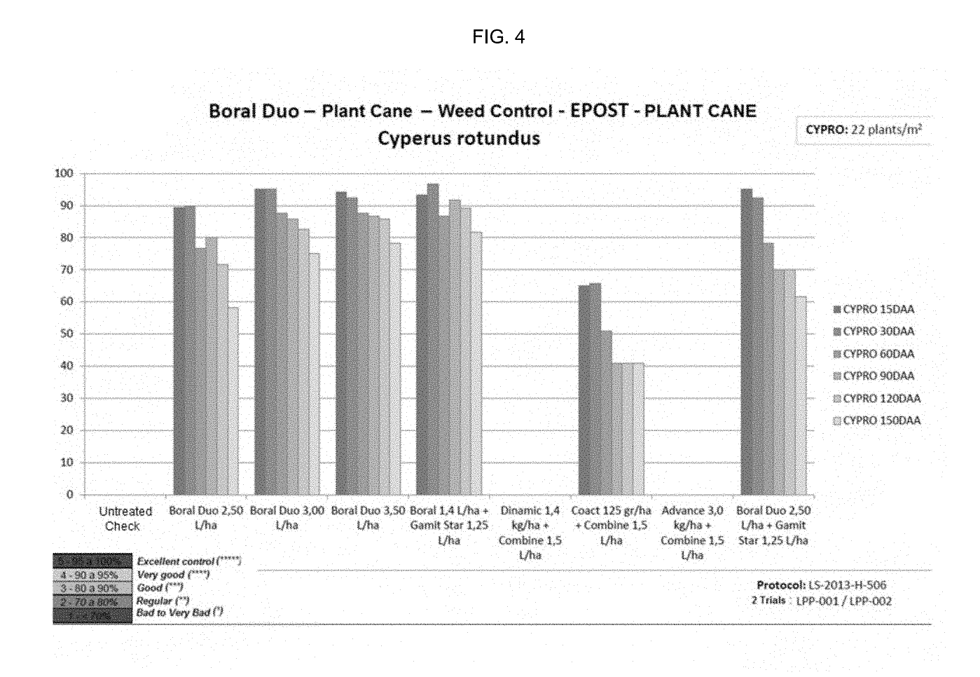

FIG. 5 refers to the performance of the herbicidal formulation of the present invention (Boral DuO—sulfentrazone and diuron association) in the control of scarlet morning glory (Ipomoea hederifolia) in sugarcane at 180 DAA.

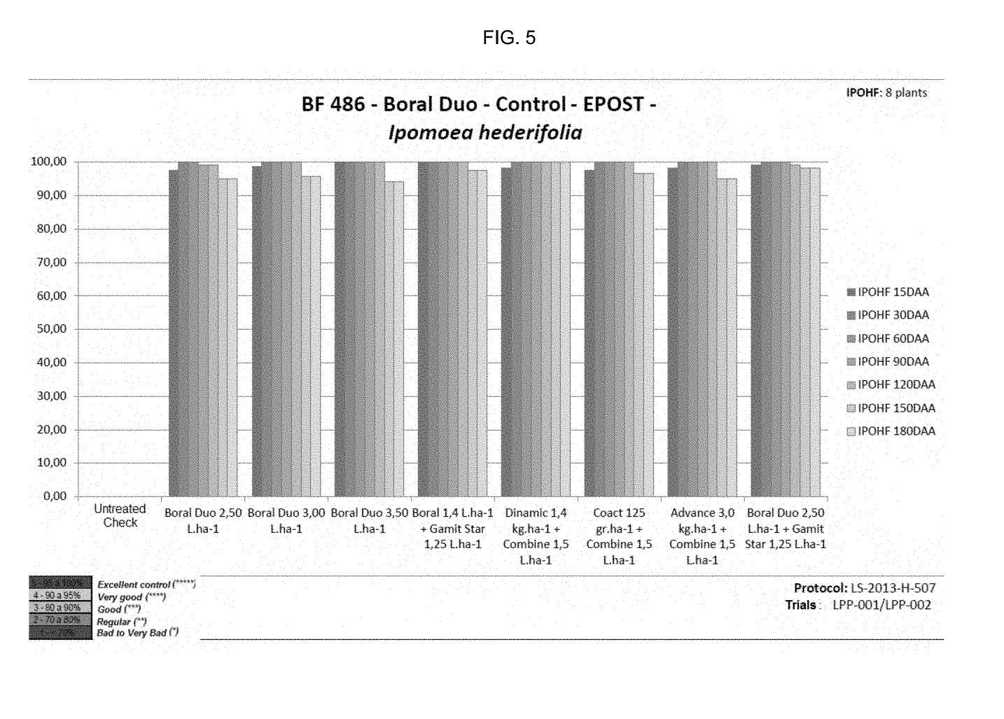

FIG. 6 refers to the efficacy of the formulation of the present invention (Boral DuO—sulfentrazone and diuron association) in the control of Guinea grass (Panicum maximum) in sugarcane.

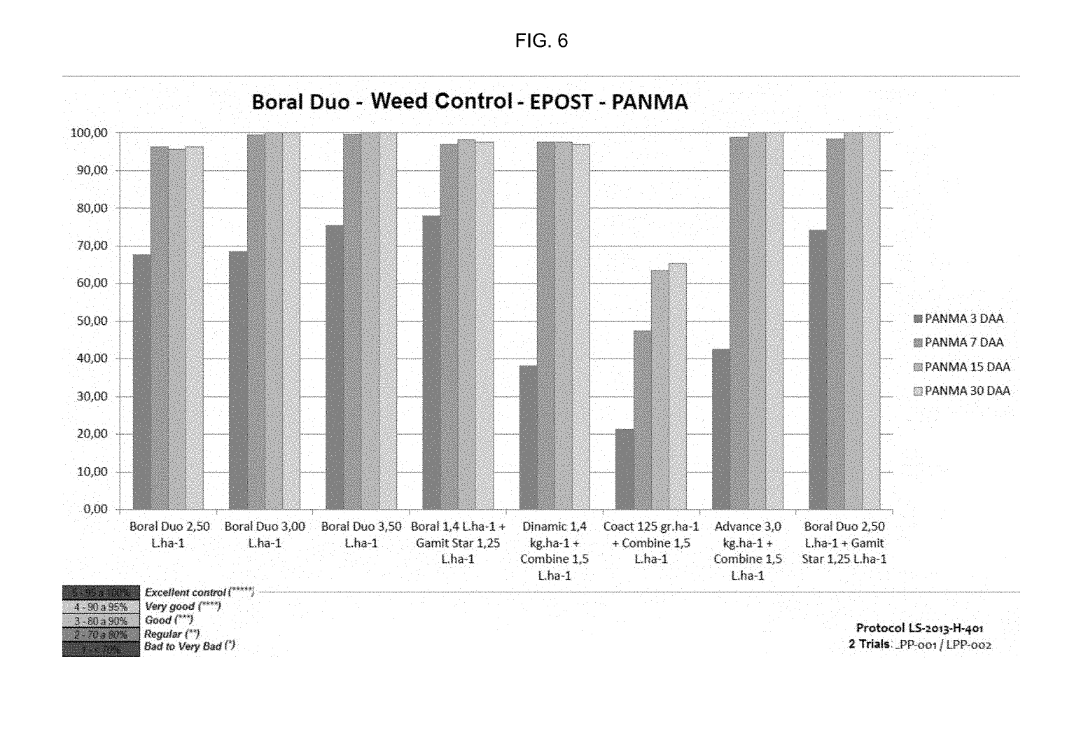

FIG. 7 refers to the efficacy of the formulation of the present invention (Boral DuO—sulfentrazone and diuron association) in the control of Surinam grass (Brachiaria decumbens) in sugarcane.

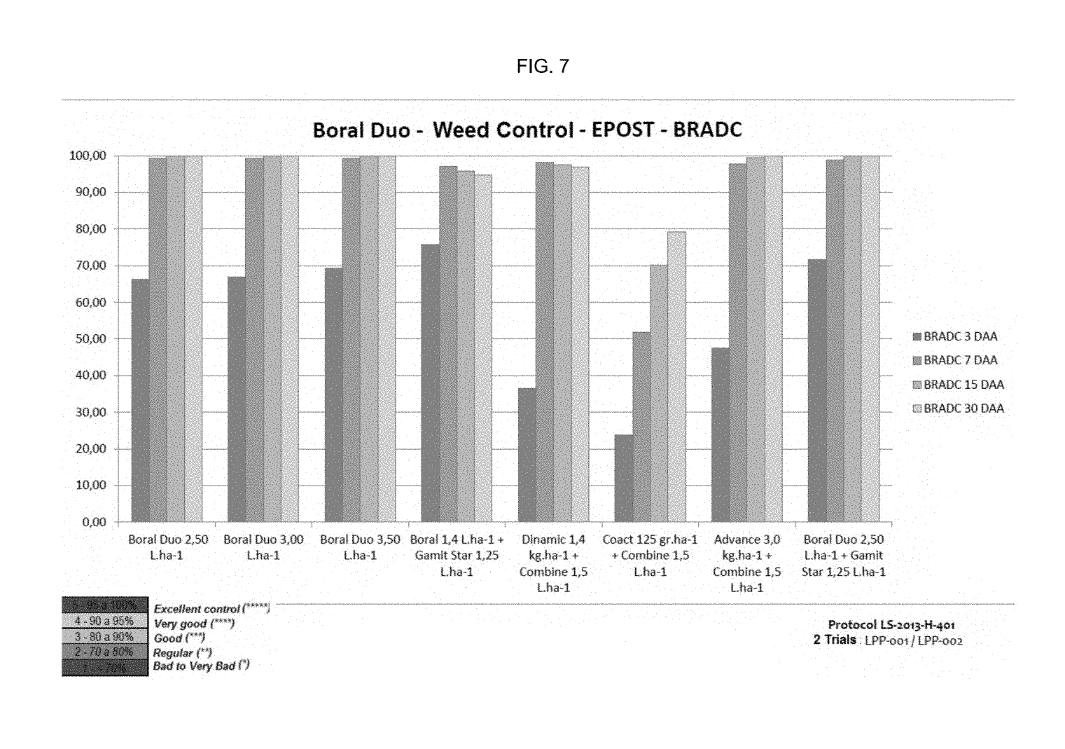

FIG. 8 refers to the performance of the formulation of the present invention (Boral DuO—sulfentrazone and diuron association) in control the crowfoot grass (Eleusine indica) in coffee plantations, when compared to other herbicides and tank mixes.

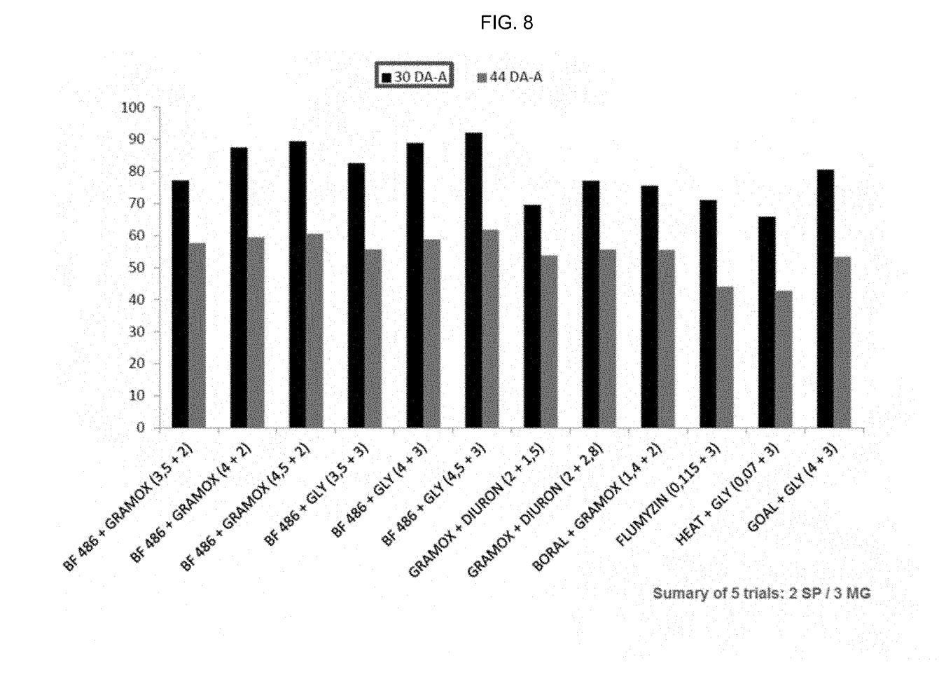

FIG. 9 refers to the performance of the formulation of the present invention (Boral DuO—association of sulfentrazone and diuron) in the control of Benghal dayflower (Commelina bengalensis) in coffee plantations, when compared to other herbicides and tank mixes.

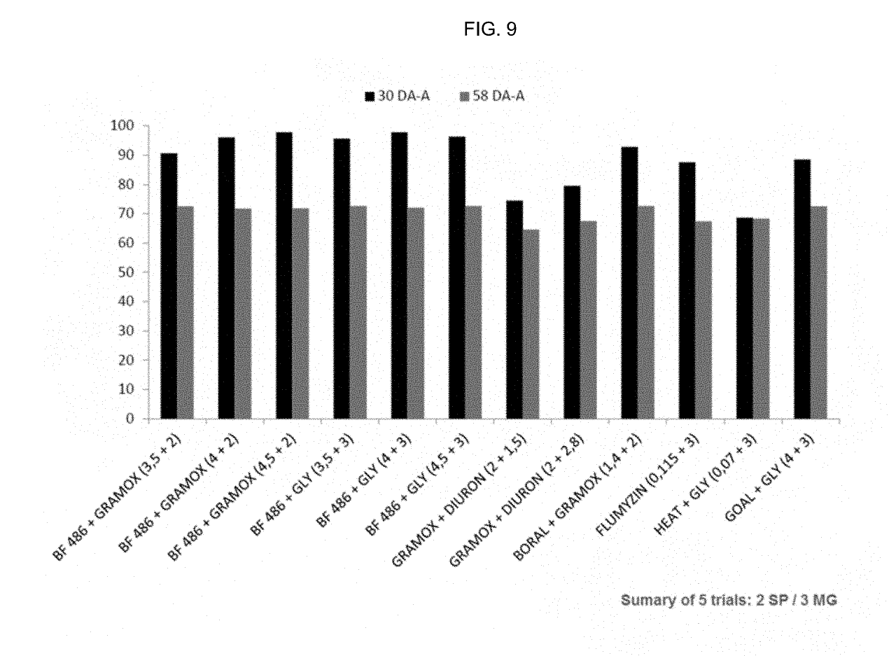

FIG. 10 refers to the performance of the formulation of the present invention (Boral DuO—sulfentrazone and diuron association) in the control of beggar-ticks (Bidens pilosa) in coffee plantations, when compared to other herbicides.

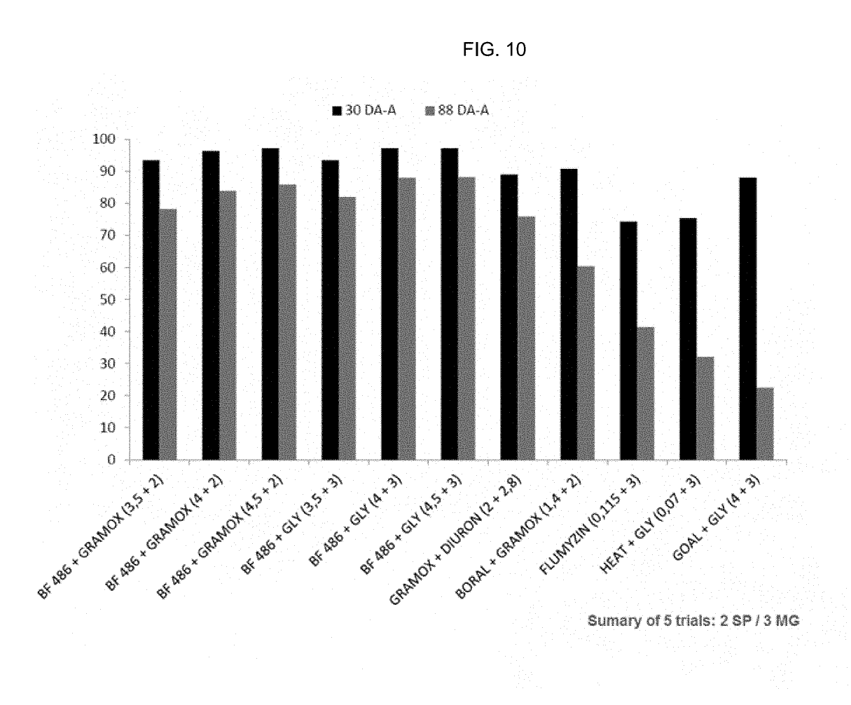

FIG. 11 refers to the performance of the formulation of the present invention (Boral DuO—sulfentrazona and diuron association) in the control of southern sandbur (Cenchrus echinatus) in citrus cultures when compared to other herbicides.

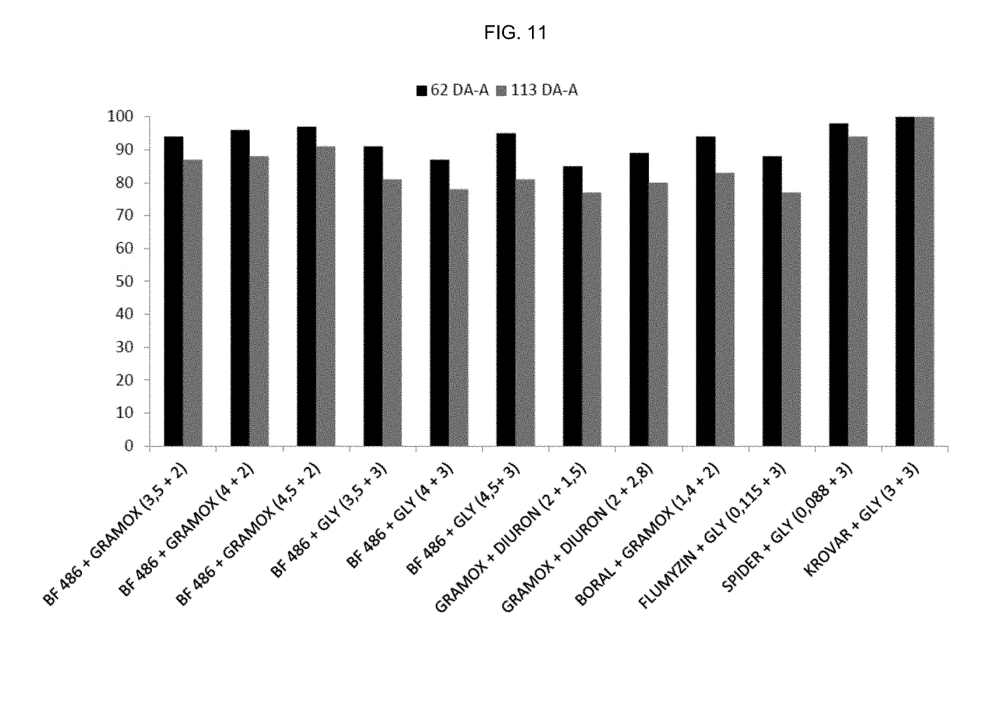

FIG. 12 refers to the performance of the formulation of the present invention (Boral DuO—sulfentrazona and diuron association) in the control of beggar-ticks (Bidens pilosa) in citrus cultures.

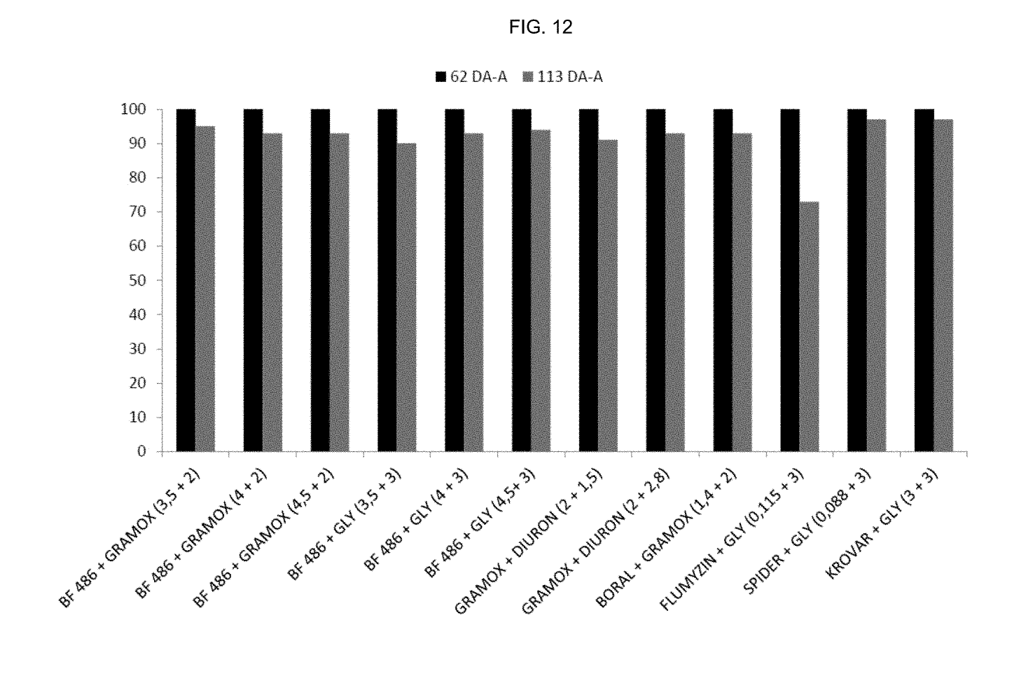

FIG. 13 refers to a chart that shows the control results of the formulation of the present invention (Boral DuO—sulfentrazona and diuron association) in the desiccation of weeds for the sowing of soybean culture.

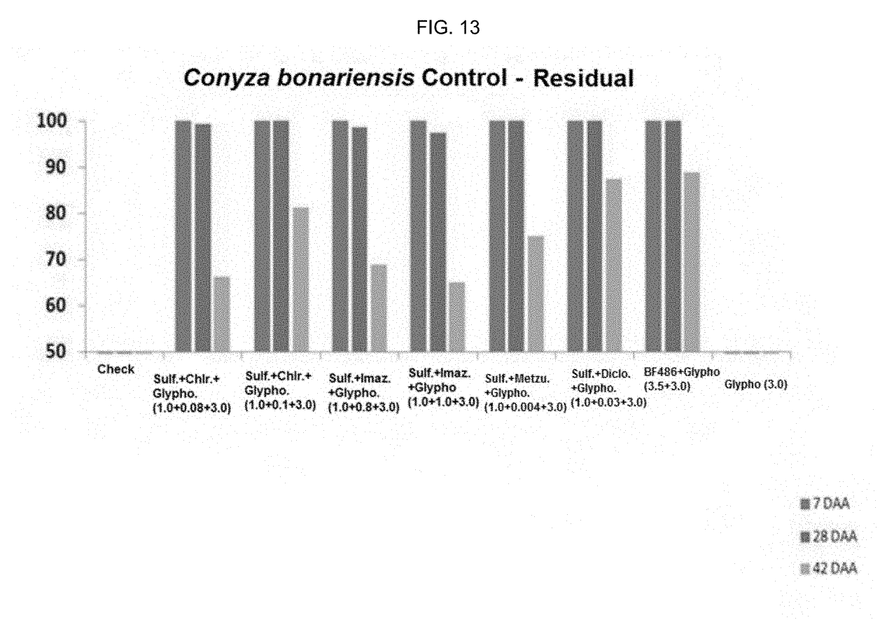

### DETAILED DESCRIPTION OF THE INVENTION

The present invention refers to a dual mode of action herbicidal formulation for consistent performance during the humid season. The formulation of the present invention comprises triazolinones in association with urea pesticide, resulting in a better and more efficient control than that obtained with all commercially available herbicides for sugarcane.

In particular, the present invention refers to a formulation which provides improved handling properties with a broad spectrum control especially for sugarcane humid season. Herbicides selected from the group of triazolinones, particularly sulfentrazone, and herbicides selected from the group of urea, particularly diruon, are usually used in sugarcane, soybean, coffee and citrus cultures, however, it was found that their action or spectrum can be maximized if these compounds are combined together.

One advantage of the formulation of the present invention is that it has a better selectivity, thus resulting in a better and more efficient control than all commercially available herbicides for sugarcane, including Dynamic (Amicarbazone 700 g/Kg—Arysta Lifescience) with Combine (Tebuthiuron 500 g/L—Dow AgroSciences) and Plateau (Imazapic 700 g/Kg—BASF) with Combine (Tebuthiuron 500 g/L—Dow AgroSciences).

Another advantage of the formulation of the present invention is related to the safety of its application of its application on the field, since the farmer can apply the formulation of the present invention as a concentrated suspension, which is more convenient and safe, since the formulation is non-flammable, has low toxicity and high concentration of the active ingredient.

Another advantage of the present invention is the association of two herbicides molecules that have different mechanisms of action, i.e., sulfentrazone that is a PPO inhibitor and diuron that is a PSII inhibitor, both together in a high performance formulation for controlling the main weeds that affect sugarcane, soybean, coffee and citrus crops. Furthermore, the formulation has high solubility, providing an excellent weed control in both plant-cane and ratoon cane in the humid season, coffee and citrus.

The association of herbicides of the present invention is based mainly on the herbicides from the group of the triazolinones, preferably sulfentrazone, and the urea herbicides, more particularly diuron. Both sulfentrazone and diuron are highly effective in controlling weeds, and when used together in association in the same formulation they have their efficacies improved.

The herbicides from the group of urea are selected from the group consisting of Tebuthiuron, Diuron, Chlorotoluron, Dimefuron, Fluometuron, Isoproturon, Isouron, Karbutilate, Linuron Methabenzthiazuron, Metobenzuron, Metoxuron, Monolinuron, Neburon, Siduron, and mixtures thereof.

The herbicides from the group of triazolinones are selected from the group consisting of sulfentrazone, amicarbazone, carfentrazone and azafenidin.

In one embodiment, the present invention refers to a formulation comprising:
(a) at least one herbicide pesticide selected from the group of triazolinones;
(b) at least one herbicide pesticide selected from the group of urea.

In a preferred embodiment, the present invention refers to a formulation comprising:
(a) at least one herbicide pesticide from the group of triazolinones, selected from sulfentrazone, amicarbazone, carfentrazone or azafenidin.
(b) at least one herbicide pesticide from the group of urea selected from Tebuthiuron, Diuron, Chlorotoluron, Dimefuron, Fluometuron, Isoproturon, Isouron, Karbutilate, Linuron, Methabenzthiazuron, Metobenzuron, Metoxuron, Monolinuron, Neburon, Siduron, and mixtures thereof.

In a most preferred embodiment, the present invention refers to a formulation comprising:
i) (a) at least one herbicide selected from the group of the triazolinones; and (b) at least one pesticide herbicide selected from the group of urea;
ii) a mixture of dispersants selected from the group consisting of:
   (a) polymeric surfactant, which may include styrene acrylic polymer, modified styrene acrylic polymer, acrylic copolymer solution, random non-ionic polymeric, amphoteric polymeric dispersant, polyester/polyamine condensation polymer, sodium salt of polyacrylate, sodium salt of acrylic acid/maleic acid copolymer, sodium salt of maleic acid/olefin copolymer copolymer, sodium salt of polycarboxylate, vinylpyrrolidone homopolymer, vinylpyrrolidone/vinylacetate copolymer; cross-linked vinylpyrrolidone and
   (b) EO/PO block copolymer, which may include block copolymer of polyalkylene oxide (PEO-PPO), butyl block copolymer, nonionic block copolymer, PEO-PPO tristyrylphenol, PEO-PPO nonylphenol, PEO-PPO butyl alcohol, PEO-PPO fatty alcohol, reverse block copolymer EO/PO and block copolymer based on EO/PO amine; and
   (c) additives for stabilizing the formulation, such as antifreeze compounds (glycol or urea), xantham gum, preservatives and anti-foaming agents.

More particularly, the present invention refers to a herbicidal formulation based on sulfentrazone mainly associated with Diuron in a concentration ranging from 35 g/L to 500 g/L of sulfentrazone and 17.5 g/L to 750 g/L of Diuron. In a preferred embodiment, the concentration of sulfentrazone is 175 g/L and the concentration of Diuron is 350 g/L.

In a non-limiting embodiment, the formulation is an aqueous suspension comprising sulfentrazone and diuron. Sulfentrazone and diuron can be present in any desired quantity and not only restricted to its suspension form, also being equally effective in the form of wettable powder (WP), oil dispersion (OD), emulsifiable concentrate (EC) or dispersible granules (WDG).

The formulation of the present invention is to be diluted in water to prepare homogenous solutions for application to foliage of a plant to kill or control the plant growth. The present invention is also directed to methods of making and using the formulations of the present invention.

In a preferred embodiment, the formulation of the present invention is mixed with other known active compounds such as insecticides, fungicides or fertilizers and growth regulators.

The formulation of the present invention can be applied by any conventional method such as powder, to furrows, foliar, microencapsulated, such as a wettable powder, wettable granule, as a concentrated solution or a solution dispersible in oil.

The present invention also refers to a method for efficiently controlling various weeds, such as the crabgrass complex (Digitaria horizontalis, Digitaria nuda and others), guinea grass (Panicum maximum), Surinam grass (Brachiaria decumbens), morning glories (Ipomoea grandifolia, Ipomoea nil, Ipomoea quamoclit, Ipomoea purpurea, Merremia cissoides and Merremia aegypta), beggar-ticks (Bidens pilosa), Java grass or purple nut sedge (Cyperus rotundus and Cyperus spp), Indian goosegrass or crowfoot grass (Eleusine indica), southern sandbur (Cenchrus echinatus), velvet bean or mucuna (Mucuna pruriens), wild poinsettia or milkweed (Euphorbia heterophylla), among other weed species as described below, comprising applying the formulation of the present invention to the plants.

The present invention also refers to a method for reducing weed competition for water, light and nutrients with the sugarcane culture, thus favoring initial crop development, production and increasing crop yield and the longevity of the sugar plantation, comprising applying the formulation of the present invention to the weeds.

The present invention furthers refers to the use of the formulation of the present invention for controlling weeds and unwanted plant pests as mentioned above and listed below.

The general concepts of the invention are described below, which should not be construed as limiting to the present invention.

The formulations listed in Table 1 were applied to sugarcane in the dosages below. The synergism of a “built-in” type formulation and the mixture of the commercially available products were evaluated for the first prototype.

TABLE 1

| | | DOSAGE |
|---|---|---|
| SAMPLE | PRODUCT | (L/Hectare) |
| Evidence | — | — |
| A | BF486-Sulfentrazone 175 g/L + Diuron 350 g/L SC | 3.5 |
| B | BF486-Sulfentrazone 175 g/L + Diuron 350 g/L SC | 4 |
| C | BF486-Sulfentrazone 175 g/L + Diuron 350 g/L SC | 4.5 |
| D | Sulfentrazone 500 g/L SC + Clomazone 800 g/L EC | 1.4 + 1.2 |
| E | Amicarbazone 700 g/Kg WG + Tebuthiuron | 1.4 + 1.5 |
| | 500 g/L Sc | |
| F | Diclosulam 840 g/Kg WG + Tebuthiuron | 0.126 + 1.5 |
| | 500 g/L Sc | |
| G | Clomazone 800 g/L EC + | 1.2 + 1.5 |
| | Hexazinone 132 g/Kg + Diuron 468 g/Kg WG | |
| H | BF486-Sulfentrazone 175 g/L + Diuron | 3.5 + 1.2 |
| | 350 g/L SC + Clomazone 800 g/L EC | |
| I | BF486-Sulfentrazone 175 g/L + Diuron | 3.5 + 1.5 |
| | 350 g/L SC + Tebuthiuron 500 g/L Sc | |
| J | Sulfentrazone 265 g/L + Tebuthiuron 310 g/L Sc | 2.65 |

Table 2 illustrates the effective control of each mixture or formulation in relation to the respective cultures and time after application.

TABLE 2
Note: DAA-days after application
Season: Humid season-February 2012

| | Control of | | Control of Digitaria | |
|---|---|---|---|---|
| | Ipomoea hederifolia (%) | | (horizontalis %) | |
| SAMPLE | 72 DAA | 171 DAA | 60 DAA | 150 DAA |
| Evidência | 0.0 | 0.0 | 0.0 | 0.0 |
| A | 100.0 | 97.0 | 100.0 | 98.0 |
| B | 98.0 | 97.0 | 100.0 | 100.0 |
| C | 100.0 | 100.0 | 100.0 | 100.0 |
| D | 100.0 | 98.0 | 100.0 | 98.0 |
| E | 100.0 | 98.0 | 98.0 | 96.0 |
| F | 100.0 | 98.0 | 100.0 | 95.0 |
| G | 95.0 | 90.0 | 100.0 | 98.0 |
| H | 98.0 | 96.0 | 100.0 | 100.0 |
| I | 98.0 | 96.0 | 100.0 | 98.0 |
| J | 98.0 | 98.0 | 100.0 | 97.0 |

The formulation of the present invention has superior control (A) compared to the treatment using a commercially available composition (E) Amicarbazone 700 g/Kg WG+Tebuthiuron 500 g/L SC and (G) Clomazone 800 g/L EC+Hexazinone 132 g/Kg+Diuron 468 g/Kg WG.

The results have been reproduced at the time of planting in different regions, which makes the present invention inventive and applicable in the treatment of the most important harmful weeds and pests of sugarcane.

TABLE 3
PROTOCOLS CONDUCTED IN THE LAST TWO YEARS

| | Internal | | | |
|---|---|---|---|---|
| Harvest | Tests | Concluded | Ongoing | Location |
| Sugarcane | 32 | 10 | 22 | São Paulo, Goiás and |
| | | | | Paraná |
| Coffee | 5 | 5 | 0 | São Paulo and Minas- |
| | | | | Gerais |
| Citrus | 4 | 4 | 0 | São Paulo |
| Soybean | 6 | 6 | 0 | Paraná, Rio Grande do |
| | | | | Sul and Mato Grosso do |
| | | | | Sul |
| TOTAL | 47 | 25 | 22 | — |

TABLE 4
List of target weeds for which the formulation of the present invention (Boral
DuO) is being registered for sugarcane in Brazil.
Boral Duo (Sulfentrazone + Diuron)

| | Scientific name | Common name |
|---|---|---|
| Sugacane, (coffee, | Amaranthus hybridus | Smooth amaranth |
| citrus, soybean)¹ | Amaranthus viridis | Slender amaranth |
| | Bidens pilosa | Beggar-ticks |
| | Brachiaria decumbens | Surinam grass |
| | Brachiaria plantaginea | Alexandergrass |
| | Cenchrus echinatus | Southern sandbur |
| | Commelina benghalensis | Benghal dayflower or wandering jew |
| | Cyperus rotundus | Java grass or purple nut sedge |
| | Digitaria horizontalis | Jamaican crabgrass |
| | Eleusine idica | Crowfoot grass |
| | Ipomoea grandifolia | Morning glory or little bell |
| | Ipomoea hederifolia | Scarlet morning glory |
| | Ipomoea nil | Picotee morning glory or ivy morning glory |
| | Sida glaziovii | Southern sida |
| | Sida rhombifolia | Southern sida |

¹cultures in the phase o registration extension

TABLE 5
List of target weeds for which the formulation of the present invention (Boral
DuO) is registered for sugarcane in Brazil.
Boral (Sulfentrazone)

| | Scientific name | Common name |
|---|---|---|
| Sugarcane, soybean, | Amaranthus viridis | Slender amaranth |
| coffee, citrus, | Brachiaria decumbens | Surinam grass |
| pineapple, tobacco | Brachiaria plantaginea | Alexandergrass |
| | Cenchrus echinatus | Southern sandbur |
| | Commelina benghalensis | Benghal dayflower or wandering jew |
| | Cyperus rotundus | Java grass or purple nut sedge |
| | Digitaria horizontalis | Jamaican crabgrass |
| | Eleusine inidca | Crowfoot grass |
| | Euphorbia heterophylla | Wild poinsettia or milkweed |
| | Ipomoea grandifolia | Morning glory or little bell |
| | Panicum maximum | Guinea grass |
| | Portulaca oleracea | Purslane or pigweed |
| | Richardia brasiliensis | Brazilian calla-lily or Brazil pusley |
| | Sida glaziovii | Southern sida |
| | Spermacoce latifolia | Buttonweed or broad-leaved buttonweed |

TABLE 6
List of targets weeds for which the herbicide Diuron is registered for
sugarcane in Brazil.
Karmex 500 (Diuron)

| | Scientific name | Common name |
|---|---|---|
| Sugarcane, | Acanthospermum australe | Paraguayan starbur |
| coffee, citrus, | Acanthospermum hispidum | Bristly starbur |
| cotton and | Amaranthus hybridus | Smooth amaranth |
| pineapple | Bidens pilosa | Beggar-ticks |
| | Brachiaria decumbens | Surinam grass or brachiaria grass |
| | Brachiaria plantaginea | Alexandergrass |
| | Cenchrus echinatus | Southern sandbur |
| | Commelina benghalensis | Benghal dayflower or wandering jew |
| | Digitaria horizontalis | Jamaican crabgrass |
| | Eleusine inidca | Crowfoot grass |
| | Emilia sonchifolia | Cupid's shaving brush or lilac tasself lower |
| | Ipomoea purpurea | Common morning glory |
| | Portulaca oleracea | Purslane or pigweed |
| | Richardia brasiliensis | Brazilian calla-lily or Brazil pusley |
| | Sida rhombifolia | Arrowleaf sida |

Those skilled in the art will appreciate that modifications can be made to the present invention without departing from the concepts disclosed in the above specification. Accordingly, the preferred embodiments described in detail herein are only for illustrative purposes and do not limit the scope of the invention.

1. A dual modal of action herbicidal formulation for controlling weeds, which comprises:
(a) at least one herbicide pesticide from the triazolinone group selected from sulfentrazone, amicarbazone, carfentrazona and azafenidin;
(b) at least one herbicide pesticide from the Urea group selected from Tebuthiuron, Diuron, Chlrotoluron, Dimefuron, Fluometuron, Isoproturon, Isouron, Karbutilate, Linuron, Methabenzthiazuron, Metobenzuron, Metoxuron, Monolinuron, Neburon, Siduron, and mixtures thereof.

2. The formulation of claim 1, wherein the triazolinone is Sulfentrazone.

3. The formulation of claim 1, wherein the urea is Diuron.

4. The formulation of claim 1, wherein the formulation is an aqueous suspension.

5. The formulation of claim 1, and further comprising a mix of dispersants selected from the group consisting of
(a) polymeric surfactant; that can include Styrene Acrylic polymer; Modified Styrene Acrylic polymer; Acrylic copolymer solution; Nonionic random polymeric; Polymeric amphoteric dispersant; Polyester/polyamine condensation polymer; Polyacrylic, Na-Salt; Maleic acid/acrylic acid copolymer, Na-Salt; Maleic acid/olefin copolymer, Na-Salt; Polycarboxylate, Na-Salt; Vinylpyrrolidone homopolymer; Vinylpyrrolidone/vinylacetate copolymer; Crosslinked Vinylpyrrolidone; and
(b) block copolymer EO/PO, that can include Polyalkylene oxide (POE-POP) block copolymer; Butyl block copolymer; Nonionic block copolymer; POE-POP tristyrylphenol; POE-POP nonylphenol; POE-POP butyl alcohol; POE-POP fatty alcohol; EO/PO Reverse block copolymer; EO/PO Amine based block copolymer; and
(c) additives for stabilize the formulation.

6. The formulation of claim 1, wherein the additives are selected from anti-freeze; xanthan gum; preservatives and anti-foam.

7. The formulation of claim 6, wherein the anti-freeze is selected from glycol and urea.

8. The formulation of anyone of claims 1 to 7, wherein the triazolinone is present in a concentration of 35 g/L to 500 fg/L and the urea is present in a concentration of 17.5 g/L to 750 g/L.

9. The formulation of claim 8, wherein the triazolinone is present in a concentration of 175 g/L of and the urea is present in a concentration of 350 g/L.

10. The formulation of claim 1, wherein the formulation is in the form of wettable granules, wettable powder, microencapsulated, foliar, in furrow, suspension concentrate, dispersable oil and emulsifiable concentrate.

11. The formulation of a claim 1, and further comprising an active compound selected from the group consisting of insecticides, fungicides, fertilizers and growth regulators.

12. A method for controlling undesirable weeds selected from crabgrass complex (Digitaria horizontalis, Digitaria nuda and others), guinea grass (Panicum maximum), Surinam grass (Brachiaria decumbens), morning glories (Ipomoea grandifolia, Ipomoea nil, Ipomoea quamoclit, Ipomoea purpurea, Ipomoea hederifolia, Merremia cissoides and Merremia aegypta), beggar-ticks (Bidens pilosa), Java grass or purple nut sedge (Cyperus rotundus and Cyperus spp), Indian goosegrass or crowfoot grass (Eleusine indica), southern sandbur (Cenchrus echinatus), velvet bean or mucuna (Mucuna pruriens), wild poinsettia or milkweed (Euphorbia heterophylla), Paraguayan starbur (Acanthospermum australe), Slender amaranth (Amaranthus viridis), Alexandergrass (Brachiaria plantaginea), Benghal dayflower (Commelina benghalensis), Lilac tasselflower (Emilia sonchifolia), Wild poinsettia or milkweed (Euphorbia heterophylla), Gallant soldier (Galinsoga parviflora), Purslane or pigweed (Portulaca oleracea), Brazilian calla-lily or Brazil pusley (Richardia brasiliensis), Flannel weed (Sida cordifolia), Southern sida (Sida glaziovii), Southern sida (Sida rhombifolia), Buttonweed or broad-leaved buttonweed (Spermacoce latifólia), wherein the method comprises applying the formulation of claim 1 to a plant.

13. A method for increasing crop yield, which comprises applying the formulation of claim 1 to a plant.
